(19) United States
(12) Patent Application Publication
(10) Pub. No.: US 2025/0373891 A1
(43) Pub. Date: Dec. 4, 2025

(54) Media Motion Comfort

(71) Applicant: Apple Inc., Cupertino, CA (US)

(72) Inventors: Ryan M. Sheridan, Huntington Beach, CA (US); Alan M. Moss, Laguna Beach, CA (US); Matthew J. Yaeger, Tustin, CA (US); Montana Reed, Cupertino, CA (US)

(21) Appl. No.: 19/203,029

(22) Filed: May 8, 2025

Related U.S. Application Data
(60) Provisional application No. 63/653,618, filed on May 30, 2024.

(51) Int. Cl. H04N 21/4402; H04N 21/442

(52) U.S. Cl. CPC H04N 21/440245; H04N 21/44218; H04N 21/44222

(57) ABSTRACT

Techniques for managing motion data for an immersive media item include receiving media data and corresponding motion data, and determining whether a motion compensation trigger is satisfied. This trigger could be based on a personal motion compensation threshold of a viewer, one or more physical characteristics of the viewer, or a user-selected motion level. If the motion compensation trigger is satisfied, a corrective action is performed on the media data to obtain adjusted media data, which is then presented on a display of an electronic device. The corrective action involves determining a prescriptive motion based on the motion data and applying this prescriptive motion to the media data.

### FIELD OF THE INVENTION

This disclosure relates generally to media streaming and more specifically to providing a metadata track with motion and comfort information.

### BACKGROUND

Media consumption is a frequent use of electronic devices. Users can use many types of electronic devices to access and stream live media content for playback. Many of these electronic devices support high-definition media playback, such as Ultra HD or 4K, on a compatible display.

In current times, it can be preferable to view media in an immersive manner. As an example, a user may wish to stream a media item on a head-mounted device. In some embodiments, different users may be more susceptible to a bad user experience based on high motion content. Thus, what is needed is a technical improvement for handling high motion data in immersive content.

### BRIEF DESCRIPTION OF THE DRAWINGS

FIG. 1 shows, in block diagram form, a simplified network diagram according to one or more embodiments.

FIG. 2 shows, in flowchart form, an example method for producing immersive content, according to one or more embodiments.

FIG. 3 shows, in flowchart form, an example method of determining motion metrics, in accordance with one or more embodiments.

FIG. 4 shows, in flowchart form, an example method of determining phobia metrics, in accordance with one or more embodiments.

FIG. 5 shows, in flowchart form, an example method for dynamically adjusting immersive content based on motion data, according to one or more embodiments.

FIG. 6 shows, in flowchart form, a technique for providing immersive media on a media distribution platform, according to one or more embodiments.

FIGS. 7A-7B show, in flow diagram form, example processes for utilizing comfort metadata, according to one or more embodiments.

FIG. 8 shows an example system diagram for an electronic device in accordance with one or more embodiments.

### DETAILED DESCRIPTION

The following disclosure is related to techniques for providing real-time feedback regarding camera motion, and providing a metadata track which encodes motion information for immersive content. In some embodiments, immersive media can be created for a variety of content, such as sports, cinematic media, and the like. During production, content may be captured which includes a range of motion characteristics or other content characteristics which may affect viewers in different ways. In particular, abrupt motion, fast motion and the like may lead to a reduced quality viewing experience for a user. Similarly, different viewers may have different tolerance levels for certain immersive content or experiences.

In order to assist production of immersive content, techniques described herein provide a real-time feedback mechanism for comfort. For example, as immersive scenes are generated or captured, techniques described herein can track or determine camera motion and other characteristics, and provide guidance as to a comfort level. For example, an immersive media item may be required to satisfy some predefined comfort criteria based on motion, content, or the like. During production, a determination may be made as to whether, based on camera motion and other indicators, the captured content satisfies predefined comfort criteria. In doing so, a media producer can understand, in real time, whether captured content will satisfy prescribed comfort level. In some embodiments, replacement or alternative scenes can be produced for the immersive media item, which can be provided for distribution to playback devices.

Further, techniques described herein provide a technique for allowing personalized immersive media which satisfies a user's personal comfort level. For example, a user who is more familiar with immersive content may be accustomed to higher levels of motion than a user just beginning to experience immersive content. To that end, a user may have a specific comfort level at which immersive media should be presented. In some embodiments, an immersive media item may be generated with alternate scenes if a particular scene exceeds a user's comfort level. For example, the particular scene can be swapped for an alternative scene which would satisfy the user's comfort metrics. In some embodiments, this is performed on a device by a metadata track which encodes motion information for the camera capturing the scene. By encoding camera motion information, a corrective action can be performed on a particular scene prior to presenting the scene to the user. Alternatively, motion information may be derived from the media data, for example at a playback device. A motion level may be determined from the media content, and compared against a threshold, for example for a specific user. In another example, some viewers may be negatively affected by certain content, and the immersive media can avoid presenting the content.

According to one more embodiments, techniques described herein provide a technical improvement to immersive media capture and playback by providing real-time feedback regarding camera motion for the production stage. Real-time feedback during the production stage provides a technical solution for ensuring that media capture satisfies user comfort metrics in real time, thereby reducing time and resources by avoiding unnecessary content capture, or by allowing alternative content capture. Further, a metadata track that incorporates comfort information provide the technical solution for different playback requirements at different devices by allowing a device to identify portions of the immersive media item which would not satisfy a particular viewer's personal comfort parameters, and perform a corrective action prior to presenting the media content to the user.

In the following description, for purposes of explanation, numerous specific details are set forth to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flowchart may be presented in a particular order. However, it should be understood that the particular flow of any flow diagram is used only to exemplify one embodiment. In other embodiments, any of the various components depicted in the flowchart may be deleted, or the components may be performed in a different order, or even concurrently. In addition, other embodiments may include additional steps not depicted as part of the flowchart. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming but would nevertheless be a routine undertaking for those of ordinary skill in the art of image capture having the benefit of this disclosure.

For purposes of this disclosure, media items are referred to as “videos.” However, in one or more embodiments, the media items referred to as “videos” could be any kind of media item including, but not limited to, audio/video media items, radio stations, streaming data items, podcasts, music videos, animations, video graphics, graphic overlays, or the like. Additionally, for purposes of this disclosure, data feeds of user device instructions, or directives, are referred to as “presentation tracks” or “presentation feeds.” However, in one or more embodiments, the data feeds referred to as “presentation tracks” or “presentation feeds” could be any kind of data feed used to direct presentation of a broadcast which includes, but is not limited to, commands that direct presentation of the broadcast, camera source data, timestamp data, transition data, graphics data, or combinations or variations thereof.

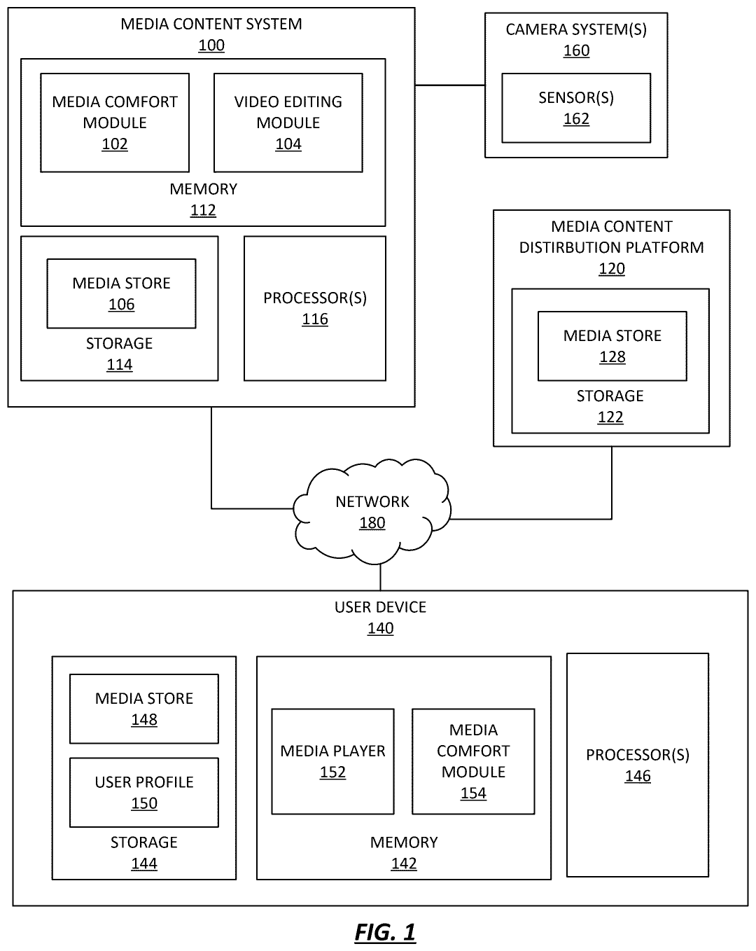

Referring to FIG. 1, a simplified block diagram is depicted of a media content system 100 communicably connected to a media content distribution platform 120 and a user device 140, for example over a network 180. User device 140 may be a multifunctional device, such as a set-top box, digital media player, mobile phone, tablet computer, personal digital assistant, portable music/video player, wearable device, or any other electronic device that includes a media playback system that can cause video content to be displayed on a high-definition screen.

Media content system 100 may include one or more servers or other computing or storage devices on which the various modules and storage devices may be contained. Although media content system 100 is depicted as comprising various components in an exemplary manner, in one or more embodiments, the various components and functionality may be distributed across multiple network devices, such as servers, network storage, and the like. Further, additional components may be used, or some combination of the functionality of any of the components may be combined. Generally, media content system 100 may include one or more memory devices 112, one or more storage devices 114, and one or more processors 116, such as a central processing unit (CPU) or a graphical processing unit (GPU), or the like. Further, processor(s) 116 may include multiple processors of the same or different type. Memory 112 may include one or more different types of memory, which may be used for performing device functions in conjunction with processor 116. For example, memory 112 may include cache, ROM, and/or RAM. Memory 112 may store various programming modules which may be executed by the processor(s) 116, including media comfort module 102, and video editing module 104.

Media content system 100 may store media files, media file data, music catalog data, video catalog data, media or video clips, statistical data, graphics data, or the like. Additional data may include, but is not limited to alternate scenes, metadata files, or the like. Media content system 100 may store data in a media store 106 within storage 114. Storage 114 may include one or more physical storage devices. The physical storage devices may be located within a single location, or may be distributed across multiple locations, such as multiple servers.

In some embodiments, media content system 100 may be communicatively coupled to one or more camera system(s) 160. Camera system(s) 160 may include one or more cameras of a same or different type. The cameras may have different capabilities, such as zoom capabilities, resolution capabilities, connectivity capabilities, or the like. Each camera may include audio and video capture capabilities. In some embodiments, one or more of the camera system(s) 160 may be configured to capture immersive content, such as 3D media. For example, the camera system(s) may include a stereocamera system from which immersive content can be produced. In some embodiments, camera system(s) 160 may include one or more sensor(s) 162. In some embodiments, sensor(s) 162 may include one or more imaging sensors, as well as other sensors configured to capture motion data from which camera motion parameters can be determined, and/or other sensors which may provide measured characteristics of the environment of the camera capturing the immersive content. Examples of sensor(s) 162 include inertial motion units (IMUs), gyroscopes, accelerometers, magnetometers, and/or other sensors configured to capture sensor data related to changes in camera position and/or orientation. Camera system(s) 160 may be connected directly to streaming media service 100, such as over a local area network, over network 180, or a combination or variation thereof.

Returning to the media content system 100, the memory 112 includes modules that include computer readable code executable by processor 116 to cause the media content system 100 to perform various tasks. As depicted, the memory 112 may include a media comfort module 102 and a video editing module 104. According to one or more embodiments, the video editing module 104 may be configured to generate and manage media content, such as content captured from camera system(s) 160. Video editing module 104 may store media content on media store 106 of storage 114 for subsequent retrieval. Portions of the media content may be stored on media store 106, such as media clips, highlights, snippets, alternative scenes, or the like. In one or more embodiments, the video editing module 104 may cause display of a graphical user interface (GUI) to receive input from a user to edit video media content displayed by the GUI. The user may interact with the GUI of video editing module 104 via a variety of methods including, but not limited to, physical touch, touchless gestures, and/or retinal tracking. Video editing module 104 may receive audio and video data feeds from a plurality of sources, such as media store 106, camera system(s) 160, or a combination thereof.

Media comfort module 102 may be configured to receive motion sensor data from sensor(s) 162, and determine comfort metrics. The comfort metrics may correspond to measurements of camera motion, content affecting a user's comfort, or the like. In some embodiments, media comfort module 102 may compare the comfort metrics to predefined motion and comfort threshold levels to identify a motion classification, determine whether a motion threshold is exceeded, or the like. For example, media comfort module 102 may be configured to generate a classification for an immersive media item, portions (such as scenes) of an immersive media item, or the like. The classification may indicate a relative motion level, such as low, medium, high, or the like. In addition, or alternatively, the media comfort module 102 may track a threshold comfort level, for example based on motion information or motion parameters, to determine whether a threshold motion is exceeded. In some embodiments, the media comfort module 102 may additionally determine other comfort parameters, such as camera pose data and phobia data. Camera pose data may include stationary characteristics of a camera in its environment. This may include, for example, scene origin point, camera scene position, altitude above sea level, height above ground level, location data, and the like. Other examples include proximity to other objects in the scene.

Video editing module 104 may provide media content to one or more devices for preview during capture, such as a head-mounted device or other playback device. For example, video data feeds may be received in real time, or near real time, while content is captured. In some embodiments, the media comfort module 102 may cause an adjustment to the preview video. For example, if the media comfort module 102 determines that a comfort metrics are not satisfied, then the immersive video may be replaced by a notification during preview. In doing so, a viewer of the preview track during production may avoid a poor or unpleasant preview viewing experience.

The media comfort module 102 made generate a metadata track for the immersive media item indicating comfort information, such as a motion comfort level, motion events, phobia events, camera motion information, or the like. The metadata track may be provided along with the immersive media item for playback. This may include, for example, a classification of camera motion for a particular portion of the immersive media item, camera motion information such as change in position, orientation, or the like, from which image data may be modified to adjust comfort metrics, or the like. In some embodiments, the media comfort module 102 may additionally generate metadata tracks for any alternative scenes which are captured for the immersive media item.

According to one or more embodiments, the media content system 100 may provide the immersive media item, alternative scenes, and/or metadata to a media content distribution platform 120 for distribution to one or more playback devices. In some embodiments, the media content distribution platform may publish the immersive media item such that the immersive media item is available to playback devices, such as user device 140. In some embodiments, media content distribution platform 120 may include one or more servers or other computing or storage devices 122 on which the various modules and storage devices may be contained. Although media content distribution platform 120 is depicted as comprising a single storage 122 and media store 128 in an exemplary manner, in one or more embodiments, the various components and functionality may be distributed across multiple network devices, such as servers, network storage, and the like. Further, additional components may be used, or some combination of the functionality of any of the components may be combined. Generally, media content distribution platform 120 may include one or more storage devices 122. Storage 122 may include one or more physical storage devices. The physical storage devices may be located within a single location, or may be distributed across multiple locations, such as multiple servers. Media content distribution platform 120 may store media files, media file data, music catalog data, video catalog data, media or video clips, statistical data, graphics data, or the like, in media store 128. Additional data may include, but is not limited to, presentation track data, dynamic metadata files, or the like. In some embodiments, the media content distribution platform may provide a badge or other indicator of high motion content such that a user browsing items hosted by the media content distribution platform 120 will be notified of items having a native high motion content. That is, the notification may indicate which immersive media items have a high motion content and may require a corrective action to satisfy user-specific comfort metrics.

User device 140 may be an electronic device on which immersive media can be viewed. For example, user device 140 may include a mobile device, a wearable device such as a head-mounted device, or other media player configured to present immersive content. User device 140 may include one or more memory devices 142, one or more storage devices 144, and one or more processor(s) 146, such as a central processing unit (CPU) or a graphical processing unit (GPU). Further, processor(s) 146 may include multiple processors of the same or different type. Memory 142 may include one or more different types of memory, which may be used for performing device functions in conjunction with processor 146. For example, memory 142 may include cache, ROM, and/or RAM. Memory 142 may store various programming modules that include computer readable code executable by processor 146 to cause the user device 140 to perform various tasks. As depicted, the memory 142 may include a media player 152 and a media comfort module 154. According to one or more embodiments, media player 152 may provide media playback of content, such as video data content received from a content delivery service such as media content distribution platform 120, camera system(s) 160, or streaming media service 100.

According to one or more embodiments, media player 152 may be configured to request media content for media content distribution platform 120. The request may be transmitted over network 180. In response, user device 140 may receive a particular immersive media item, along with ancillary content, such as alternative scenes, metadata, and the like. Alternatively, the request may include information regarding user specific comfort parameters. In response, the media content distribution platform 120 may determine whether alternative scenes or other content should be provided, and provide the immersive media content and additional items determined to be needed based on the user specific comfort parameters. For example, the media content distribution platform 120 may only distribute alternative scenes if it is determined that a user specific comfort level for user device 140 would be exceeded by the immersive media content. According to one or more embodiments, the user specific comfort parameters may be stored as part of user profile 150 in storage 144. The user profile 150 made be used to manage user comfort parameters, such as a user specified comfort level or the like.

Once the immersive media item and ancillary content are received, the media player 152 may work in conjunction with the media comfort module 154 to provide a personalized viewing experience of the immersive media item which satisfies a user's comfort metrics. For example, the media comfort module 154 may determine whether a local user's comfort metrics would be exceeded. The motion level of the content may be determined, for example from metadata corresponding to the media item, or may be determined from the media item at the playback device. For example, motion data, such as motion scores, motion vectors, or the like, may be generated based on motion within the scene. In response to a determination that the user's comfort metrics would be exceeded, the media comfort module 154 may perform a corrective action on the immersive media item in order to cause the comfort metrics of the immersive media item to satisfy the user specific comfort metrics. As an example, if a particular scene exceeds a user's comfort metrics, the scene may be replaced with an alternative scene hosted by the media content distribution platform 120. As another example, the portion of the immersive media item which exceeds the comfort metrics may be adjusted based on camera motion information encoded in the metadata to adjust the media item such that the adjusted media item satisfies a user's comfort metrics. This may include applying a prescriptive motion to the image data by warping the image dataor reprojecting the image data, changing a level of immersiveness of the media item (such as switching from a 3D view to a 2D view), changing a field of view of the image data, or the like. As another example, a particular scene may be omitted, obstructed with a notification, or the like. In some embodiments, the immersive content, ancillary content, and/or adjusted immersive content may be stored for later playback on media store 148.

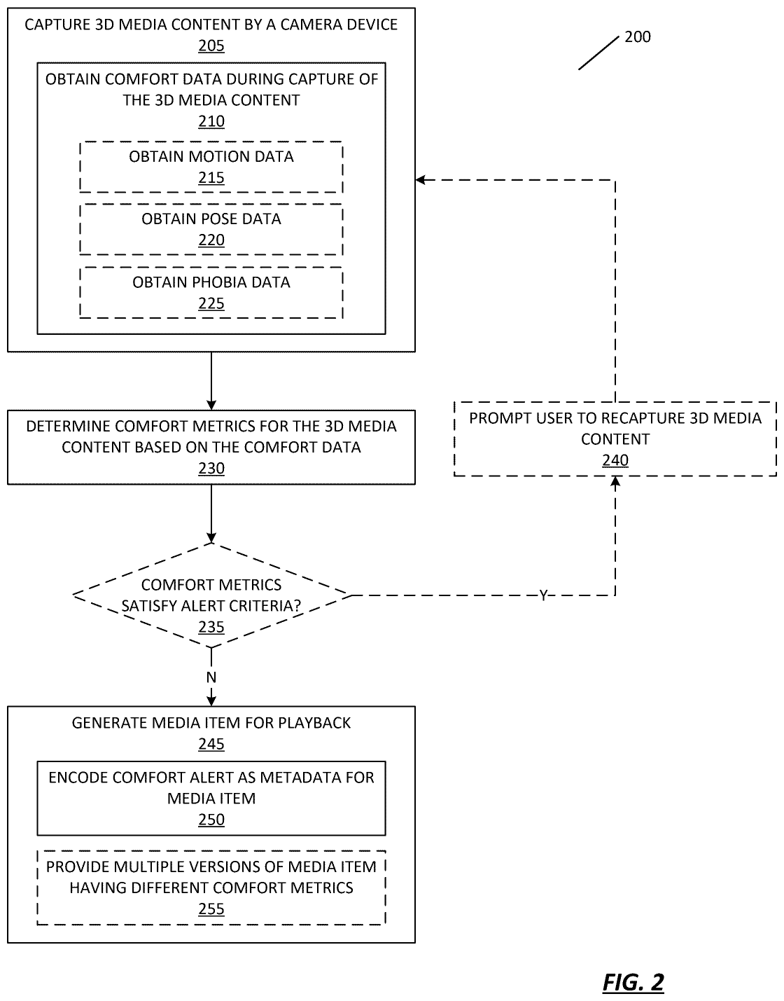

Turning to FIG. 2, a flowchart 200 is presented for producing immersive content, according to one or more embodiments. In particular, flowchart 200 shows an example technique for producing immersive content along with comfort information, in accordance with one or more embodiments. For purposes of explanation, the following processes will be described in the context of FIG. 1. However, the various actions may be taken by alternate components. In addition, the various actions may be performed in a different order. Further, some actions may be performed simultaneously, and some may not be required, or others may be added.

The flowchart 200 begins at block 205, where 3D media content is captured by one or more camera devices. The one or more camera devices may include one or more stereoscopic camera devices configure it to capture image data which is presented in an immersive context. At block 210, capturing the 3D media content includes obtaining comfort data from the camera device capturing the media content. As described above, the comfort data may include sensor data from the one or more cameras or camera systems indicating characteristics of the camera position and/or orientation in the form of pose data 220. In some embodiments, comfort data may include motion data, such as changes in the camera position and/or orientation, as shown at bock 215. The motion data may be captured or derived from sensor data, for example, from an IMU, gyroscope, accelerometer, or some combination thereof. Further, as shown at block 225, comfort data may include phobia data. Phobia data may identify detected objects or events in a captured scene which belong to a predefined classification for which comfort data should be generated. This may happen, for example, for objects or experiences which are detected in image data captured by the camera system(s).

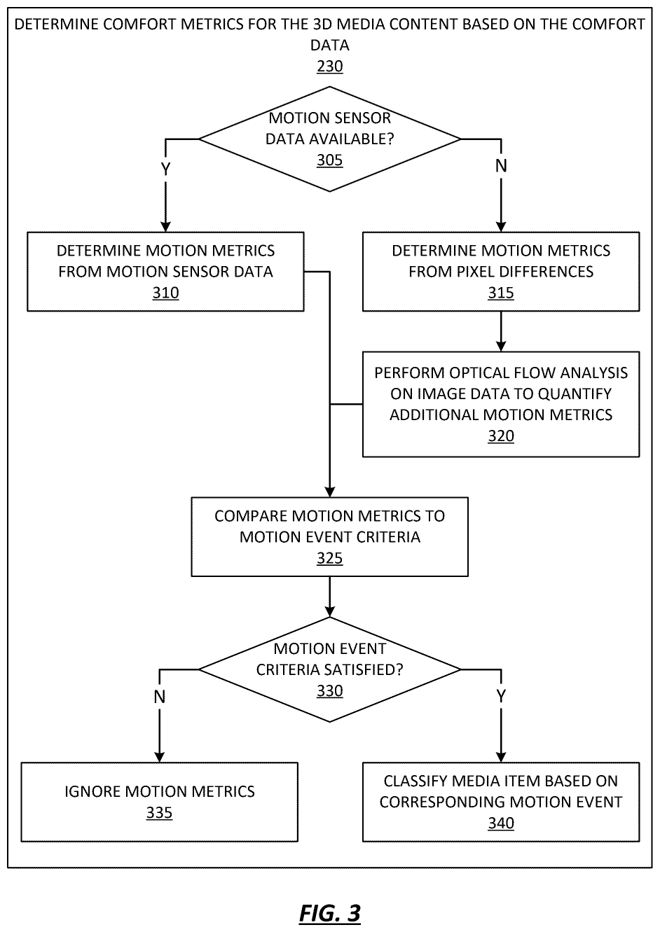

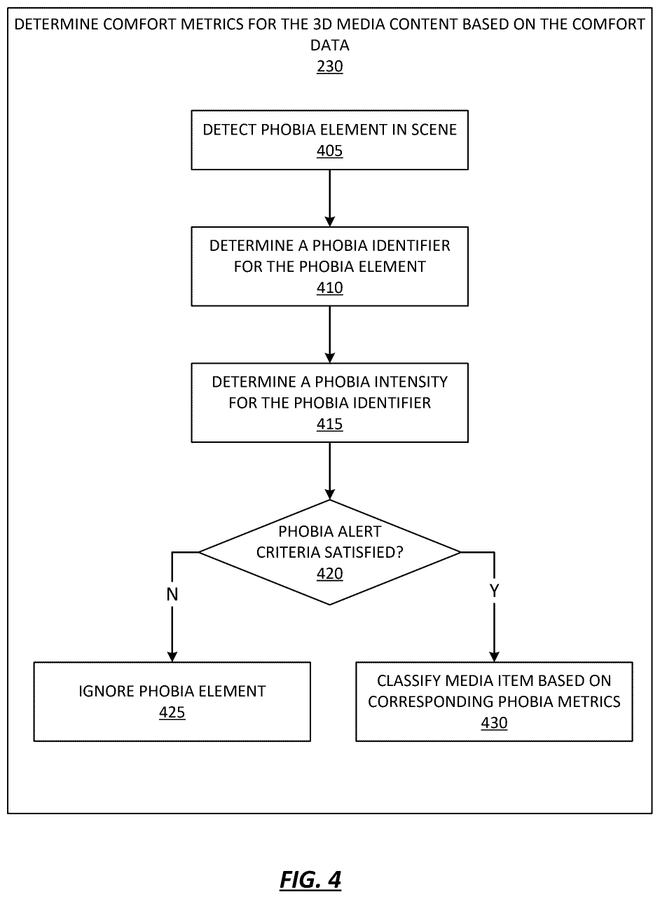

The flowchart 200 continues at block 215, where comfort metrics are determined for the 3D media content based on the comfort data. The comfort metrics may be determined in real time as the media content is captured, and/or after the media content is captured. In some embodiments, the comfort metrics may indicate how much motion is present in the scene, abrupt changes in motion in the scene in the form of motion events, phobia events, or the like. Determination of the comfort metrics will be described in greater detail below with respect to FIGS. 3-4.

Optionally, at block 235, a determination is made as to whether the comfort metrics satisfy alert criteria during production. For example, as image content is captured, a device may determine a motion parameters, phobia parameters, or the like for the captured content. The comfort metrics may be considered to satisfy the alert criteria if a motion event or phobia event is identified. As another example, the comfort metrics may be considered to satisfy the alert criteria if one or more of the comfort metric values satisfy a predefined threshold for that comfort metric. If the alert criteria is satisfied, then the flowchart proceeds to block 240, and a user is prompted to recapture the 3D media content. The recaptured 3D media content may then be used as a replacement scene in the immersive media item, or may be provided as an alternative scene as part of ancillary content for the immersive media item. Accordingly, a playback device can then choose between the scene that satisfied the alert criteria, and a scene which has been recaptured at block 240. The flowchart 200 then returns to block 205, where the 3D media content is recaptured.

Returning to block 235, if the comfort metrics are not determined to satisfy an alert criteria, or if optional block 235 is skipped, then the flowchart concludes at block 245. At block 245, the immersive media item is generated for playback. In some embodiments, the immersive media item may be generated for playback using a video editing tool to finalize a video media item. In addition, as shown at block 250, generating the media item for playback includes encoding the comfort data as metadata for the media item. As described above, the comfort data may include camera motion information which can be used to adjust the captured video content to perform a corrective action, or an indication of a portion of the media item for which the alert criteria was satisfied at block 235. Additionally, or alternatively, the encoded comfort data may include at least some of the comfort metrics determined at block 230. As described above, the metadata may be generated for the immersive content, as well as ancillary content, such as alternative scenes captured for the immersive media item. Optionally, as shown at block 255, multiple versions of the media item may be generated having different comfort metrics. For example, rather than providing a single immersive media item with ancillary content, such as alternative scenes or the like, different full versions of the immersive content may be generated using the alternative scenes, thereby providing multiple versions of a same immersive media item which satisfy different comfort thresholds.

Turning to FIG. 3, a flowchart is detected of an example technique for determining comfort metrics, in accordance with one or more embodiments. In particular, FIG. 3 shows an example of determining at least some of the comfort metrics described above with respect to block 230 of FIG. 2. For purposes of explanation, the following processes will be described in the context of FIG. 1. However, the various actions may be taken by alternate components. In addition, the various actions may be performed in a different order. Further, some actions may be performed simultaneously, and some may not be required, or others may be added.

The flowchart begins with a determination at block 305 as to whether motion sensor is available. In some embodiments, the one or more camera system(s) 160 may capture various types of sensor data. Motion sensor data may be determined, for example, if an IMU or the motion sensor is operable. As another example, motion sensor data may be available, for example, based on a confidence value for the captured motion data satisfying a predefined confidence threshold. For example, the confidence value may indicate a likelihood that a calibration of the motion sensor is accurate.

If a determination is made that the motion sensor data is available, then the flowchart proceeds to block 310, and motion metrics are determined from the motion sensor data. Motion metrics may indicate various measurements or classification of camera motion based on the motion sensor data. Motion metrics may include data used to determine motion, such as camera pose and/or orientation. Other examples include angular rotation, accelerometer data, which may be filtered relative to earth's gravity, magnetic field, and heading. The motion metrics may be determined, for example, based on measurements of change of position and/or orientation of the camera causing the captured image to move in the frame or series of frames. In some embodiments, the motion metrics may additionally be based on camera settings, such as zoom, and/or image content, such as how fast an object is moving in the scene. The motion metrics may include a weighted metric based on various considerations, including changing camera position or orientation, movement of an object in the scene, or the like.

Returning to block 305, if a determination is made that motion sensor data is not available, the system can generate some motion metrics through image analysis. Thus, the flowchart proceeds to block 315, and motion metrics are determined from pixel differences across frames in the media content. In some embodiments, a motion score can be determined from the pixel comparison. The motion score may indicate a magnitude and/or direction of a motion. The flowchart proceeds to block 320, where optical flow analysis is performed on the image data to quantify additional motion metrics. The additional motion metrics may include, for example, rotational motion, perpendicular motion, horizontal pan, vertical pan, and the like.

After block 320, or after block 310, the flowchart proceeds to block 325, and the motion metrics are compared to motion event criteria. In some embodiments, motion event criteria may be defined by one or more threshold values for one of more of the motion metrics. As another example, motion event criteria may correspond to a set of predefined motion events. That is, a particular motion event may be detected based on a predefined set of motion criteria being satisfied. The motion event can be detected based on one or a combination of motion metric values. Example of motion event include:
level departure—the camera is no longer in its nominal horizontal level state, as calibrated by the user;
tumble—the camera orientation changed from a steady state to a high rotation rate on at least two axis;
drop—the camera experiences rapid vertical acceleration from a steady state;
shock—the camera was physically hit by an object at high speed, from any direction;
roll—the camera experience rapid roll movement from a steady state;
pan—the camera experiences rapid pan movement from a steady state;
tilt—the camera experiences rapid tilting movement from a steady state
heave—the camera detects a period of cyclical vertical up and down motion after a steady state period;
sway—the camera detects a period of cyclical lateral and/or longitudinal motion after a steady state period; and
vibration—the camera detects high or low amplitude, but high frequency vibration in any direction.

The flowchart proceeds to block 330, where a determination is made as to whether motion metrics satisfy the motion event criteria. The criteria may differ for each motion event, and may correspond to threshold values or other predefined values which define the event, as described above. If a determination is made that motion event criteria are not satisfied, then the flowchart concludes at block 335, and the motion metrics are ignored with respect to motion events. That is, the motion metrics may be used for other types of event determinations.

Returning to block 330, if a determination is made that the motion event criteria is satisfied, then the flowchart concludes at block 340, and the media item is classified based on the corresponding motion event, such as the motion event for which the motion event criteria were satisfied. According to some embodiments, each of the predefined motion events may be associated with an event identifier, which may be encoded into metadata in order to identify the motion event type. In some embodiments, the entire media item may be classified based on the motion event. Additionally, or alternatively, a particular scene, or portion of the media item, may be classified based on the motion event. In some embodiments, by classifying a particular scene based on the motion event, the portion of the media item containing the motion event can be identified in order to resolve the motion event at the playback side.

Turning to FIG. 4, a flowchart is detected of an example technique for determining phobia metrics, in accordance with one or more embodiments. In particular, FIG. 4 shows an example of determining at least some of the comfort metrics described above with respect to block 230 of FIG. 2. Some viewers may be negatively impacted based on individual phobias. Although phobias differ among viewers, some phobias are shared among larger portions of the viewers and, thus, can be identified for purposes of viewing comfort. For purposes of explanation, the following processes will be described in the context of FIG. 1. However, the various actions may be taken by alternate components. In addition, the various actions may be performed in a different order. Further, some actions may be performed simultaneously, and some may not be required, or others may be added.

The flowchart begins at block 405, where phobia elements are detected in the scene. In some embodiments, objects or characteristics of a scene may be detected that correspond to a set of predefined phobias. This may include certain animals or insects, certain contexts of the camera such as being underwater, high above the ground, or in an enclosed space, or certain situations, such as within a crowd or the like. Examples of phobia types include:
heights—being high above the round with feet on a rigid object, such as a balcony, top of a ladder, or in the basket of a hot air balloon;
flying/floating—being high above the ground with nothing to stand on;
personal space—the camera captures the scene such that the viewer appears close to another person;
snake—a snake is visible in the scene;
spider—a spider is visible in the scene;
rat—a rat is visible in the scene;
dog—a dog is visible in the scene;
confined spaces—the camera is within an enclosed space apparent to the viewer; and
being underwater—the camera captures a shot from an underwater perspective.

The flowchart proceeds to block 410, where a phobia identifier is determined for the particular phobia. For example, each of the predefined phobias may be associated with a particular identifier. In some embodiments, multiple phobia types may be associated with a common identifier, such as animal phobias or the like.

At block 415, a phobia intensity is determined for the phobia identifier. The phobia intensity may correspond to a value for the phobia identifier based on how apparent the phobia is in the scene. For example, a close-up view of a live snake will have a higher intensity value than a rubber snake on a shelf in a background. To that end, intensity may be based on the type of phobia as well as how that phobia element appears in the scene. Thus, the determination for intensity may be based on a combination of features such as proximity, elapsed time the phobia is visible, and the like.

The flowchart proceeds to block 420, where a determination is made as to whether a phobia alert criteria is satisfied. The criteria may differ for each phobia event, and may correspond to threshold values, such as phobia scores, or other predefined values which define the event. For example, the phobia type and/or phobia intensity may be used to determine a phobia score for the phobia event. If a determination is made that phobia alert criteria are not satisfied, then the flowchart concludes at block 425, and the phobia element is ignored.

Returning to block 420, if a determination is made that the motion event criteria is satisfied, then the flowchart concludes at block 430, and the media item is classified based on the corresponding phobia event, such as the phobia type for which the phobia alert criteria were satisfied. According to some embodiments, each of the predefined phobia types may be associated with a phobia identifier, as described above with respect to block 410. The phobia identifier, intensity score, and/or phobia score may be encoded into metadata in order to identify the phobia event type. In some embodiments, the entire media item may be classified based on the phobia event. Additionally, or alternatively, a particular scene, or portion of the media item, may be classified based on the phobia event. In some embodiments, by classifying a particular scene based on the phobia event, the portion of the media item containing the phobia event can be identified in order to resolve the phobia event at the playback side.

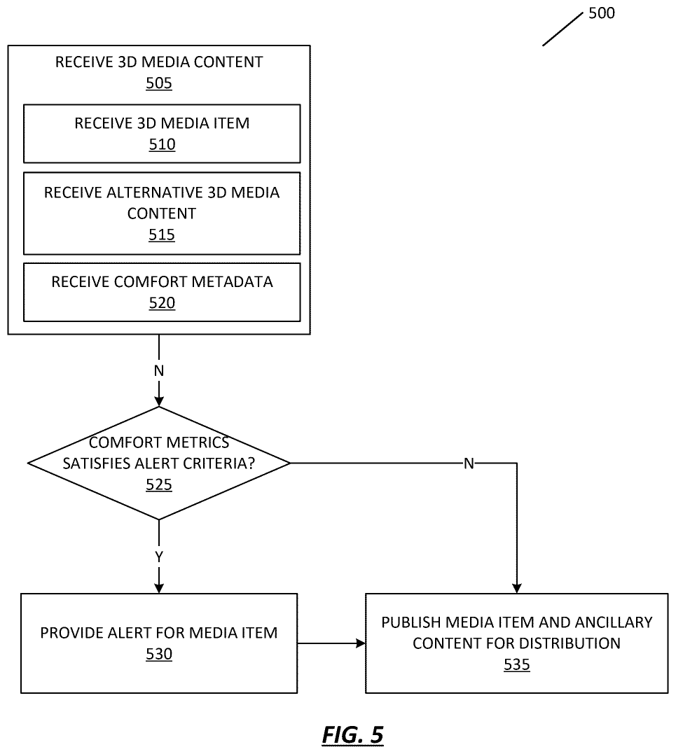

In some embodiments, the different versions of the immersive media item, or the immersive media item and the encoded metadata and other ancillary items, may be published to a media distribution platform to be made available to playback devices. FIG. 5 shows, in flowchart form, a technique for providing immersive media on a media distribution platform, according to one or more embodiments. For purposes of explanation, the following processes will be described in the context of FIG. 1. However, the various actions may be taken by alternate components. In addition, the various actions may be performed in a different order. Further, some actions may be performed simultaneously, and some may not be required, or others may be added.

The flowchart 500 begins the block 505, where 3D media content is received at the media distribution platform. In some embodiments, the 3D media content may be received when a content creator or other user associated with the creation or generation of immersive media content uploads or otherwise provides the 3D media content to the platform for publication. According to our embodiments, the 3D media content may include an immersive media item, such as a 3D media item, received at block 510. In addition, ancillary content may additionally be received, such as, at block 515, alternative 3D media content. This may include, for example, alternate scenes or other portions of media content which may be used to replace portions of the immersive media item in order to adjust comfort metrics for the immersive media item. In some embodiments, the alternative 3D media content may include, for example, overlays or other graphical items used to obstruct the motion or content in the scene, thereby resolving comfort issues for a user during playback.

Additionally, receiving 3D media content at block 505 also includes receiving comfort metadata at block 520. The comfort metadata may include a metadata track that includes data indicative of camera motion for the immersive media item. In some embodiments, the comfort metadata may be a timed metadata track which can be aligned with the immersive media item in order to provide comfort information for different portions of the immersive media item. In some embodiments, the comfort metadata may include metrics such as camera motion information indicative of how a camera moved during capture of one or more portions of the immersive media item, phobia metrics for the scene, or the like. That is, the comfort metadata may include a determined comfort score, as well as data indicative of various comfort parameters such as motion, phobias, or the like. For example, with respect to motion metrics, the metadata may include a measure of the camera motion, such as velocity, direction, rotation, acceleration, and the like.

The flowchart 500 continues to block 525, where a determination is made as to whether comfort metrics from the comfort metadata satisfy alert criteria. In some embodiments, the criteria at block 525 may refer to one or more thresholds or other conditions for which one or more badges or other indicators are appended to a listing of the 3D media content for a playback device. For example, if the comfort metadata indicates that the immersive media item contains a high motion scene or event, the comfort metrics may be determined to satisfy the alert criteria at block 525. In some embodiments, the platform may be configured to perform additional or alternative determinations for whether to identify comfort information for the immersive media item in a listing of the immersive media item by the platform. For example, the platform may include one or more programming modules configured to ingest the comfort metadata from block 520, and make a determination as to whether one or more indicators should be provided. The determination may be made, for example, based on an average comfort score, a maximum score for the immersive media content, a relative amount of the media item associated with a high comfort score, or the like.

If the determination is made at block 525 that the comfort metrics satisfy the alert criteria, then the flowchart 500 proceeds to block 530, and the platform provides an indicator for the media item, such as an indicator related to high motion, or an indicator associated with a particular phobia. The indicator may be a badge or other visual indicator, or textual indicator. The flowchart 500 then concludes at block 535, where the media item and the ancillary content are published for distribution. The media item and ancillary content are also provided for distribution in response to a determination that the comfort metrics do not satisfy the alert criteria at block 525. In some embodiments, the media item may be published to the platform with an indication that the media item is available for streaming or download. In some embodiments, the media item may be presented along with information about ancillary data, such as the availability of alternative scenes or other content which can be used to adjust the comfort metrics for the media item.

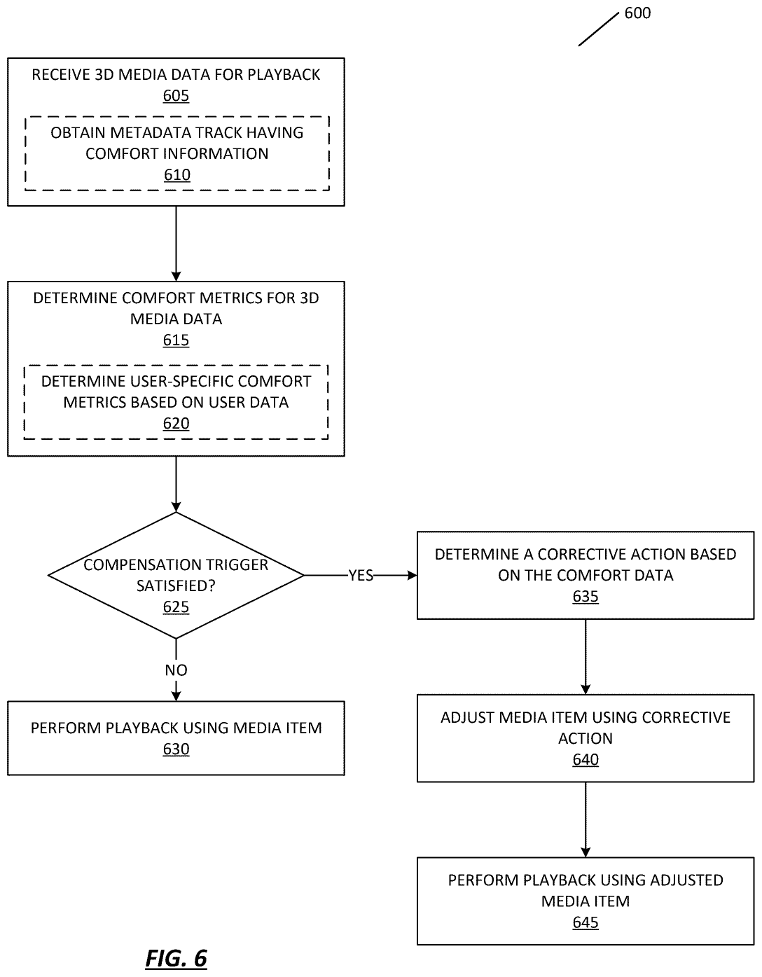

As described above, a playback device can request the immersive media item for playback, for example by streaming or download. FIG. 6 shows, in flowchart form, an example method for dynamically adjusting immersive content based on motion data, according to one or more embodiments. For purposes of explanation, the following processes will be described in the context of FIG. 1. However, the various actions may be taken by alternate components. In addition, the various actions may be performed in a different order. Further, some actions may be performed simultaneously, and some may not be required, or others may be added.

The flowchart 600 begins at block 605, where a playback device receives the 3D media data, for example, from a media distribution platform. As shown at block 610, receiving the 3D media data may optionally include obtaining a metadata track having comfort information. In addition, other ancillary items for the 3D media data may be received, such as alternative 3D media data or the like. According to some embodiments, the metadata track may be a timed metadata track configured to align comfort information with the 3D media data, such as an immersive media item.

In some embodiments, the 3D media may be captured by multiple cameras. For example, the 3D media may include stereoscopic media, having a left eye image and a right eye image. As another example, the 3D media may include immersive media in the form of multiview content, such that different parts of a scene are captured by different cameras. In these cases, the metadata may further include information about the camera that captured the media. For example, while the general lens geometry may be known, manufacturing differences can result in different lenses having different optical characteristics, leading to different optical defects. These optical characteristics may result in distortions during rendering and playback. To that end, camera-specific adjustment information may be provided in the form of lens-specific calibration data, which can be used to resolve camera-specific optical detects. In some embodiments, the lens-specific calibration data may be provided in the metadata such that the playback device can adjust or refine the decoded image data to address the defects. The lens-specific calibration data may be lens-specific, and may address issues in the lens itself, sensor to lens positioning, or the like, which may be determined during a calibration stage for the camera. According to one or more embodiments, the lens-specific calibration data may be encoded in the metadata as parametric functions or other geometric information such as a mesh representation. To that end, the 3D media data may be received with an indication of a camera from which the media data, or a particular portion of media data, was captured. The metadata track may include lens-specific calibration data related to cameras that captured the 3D media data.

The flowchart 600 proceeds to block 615, where comfort metrics are determined for the media data. According to some embodiments, if received, the comfort metrics may be determined from the metadata track. Alternatively, the comfort metrics may be determined based on characteristics of content in the media data. For example, the media data may be analyzed for motion in the scene or common phobias in the scene. The motion may be determined, for example, in the form of motion vectors, motion scores, or the like. In some embodiments, the comfort metrics may be determined prior to playback, and may be determined for the entire immersive media item. Alternatively, the comfort metrics may be determined from the media track dynamically, for example during playback. In some embodiments, the comfort metrics may include a score determined from the media content system 100, or the media content distribution platform 120. In some embodiments, the comfort metrics may be agnostic as to user specific parameters. Additionally, or alternatively, as shown at optional block 620 the user device 140 may determine user-specific comfort metrics, for example, based on the provided comfort metrics in the metadata track, the camera motion information encoded in the metadata track, motion detected within the media data and/or user specified parameters. For example, user-specific parameters for determining comfort metrics may be associated with a user profile, such as a personal threshold for high motion, personal phobias, or the like.

The flowchart proceeds to block 625, where a determination is made as to whether a compensation trigger is satisfied. The compensation trigger may be one or more parameter values and may be based on one or more of user-specific comfort metrics, a user agnostic comfort score from the metadata track, camera motion information from the metadata track, or the like. The compensation trigger may therefore indicate one or more parameters which indicate that corrective action should be taken on the immersive media item prior to presenting the immersive media item to the user. The compensation trigger may be a comfort score indicating a threshold level of motion. In some embodiments, the motion compensation may differ based on whether the comfort metrics are derived from the metadata, from motion or content in the scene, or some combination thereof. For example, a user may be more or less sensitive to motion in a scene as opposed to camera movements.

In some embodiments, the determination may be made in real time, for example, during playback of the immersive media item. Alternatively, the determination may be made prior to playback beginning. If the determination is made at block 625 that a compensation trigger is not satisfied, then the flowchart 600 concludes at block 630, and playback is performed using the immersive media item as provided by the platform. In some embodiments, the process described a flowchart 600 is performed continuously during playback and, as such, the flowchart 600 may return to block 605, where the determination is made for additional segments of the immersive media content.

Returning to block 625, if a determination is made that a compensation trigger is satisfied, then the flowchart 600 proceeds to block 635, where a corrective action is determined based on the comfort data. The corrective action may include, for example, warping or otherwise adjusting the video content to compensate for camera motion, swapping or removing video content causing the compensation trigger to be satisfied, presenting a notification to a user regarding the compensation trigger being satisfied, or the like.

The flowchart 600 proceeds to block 640, where the media item is adjusted using the corrective action. For example, a scene which causes the compensation trigger to be satisfied may be replaced with an alternative scene provided with the 3D media data. In another example, the camera motion corresponding to the video content causing the motion compensation trigger to be satisfied can be identified. The corrective action may include using the camera motion information to compensate for the camera motion in order to reduce the motion of the scene. For example, the image data may be filtered or warped so as to include less motion, such as reprojecting image data in an opposite direction of the camera motion to compensate for the camera motion, thereby applying a prescriptive motion to the image data. As another example, if the presence of a phobia causes the compensation trigger to be satisfied, a badge or other alert may be provided to a user prior to the scene.

The flowchart 600 concludes that block 645, where playback is performed using the adjusted media item. The playback may be performed on a user device configure it to support immersive media playback. Accordingly, the adjusted media item may differ from an immersive media item as provided by the platform. Further, the adjusted media item played at one user device may differ from a version of the immersive media item played at another playback device, for example, based on differing compensation triggers for different users.

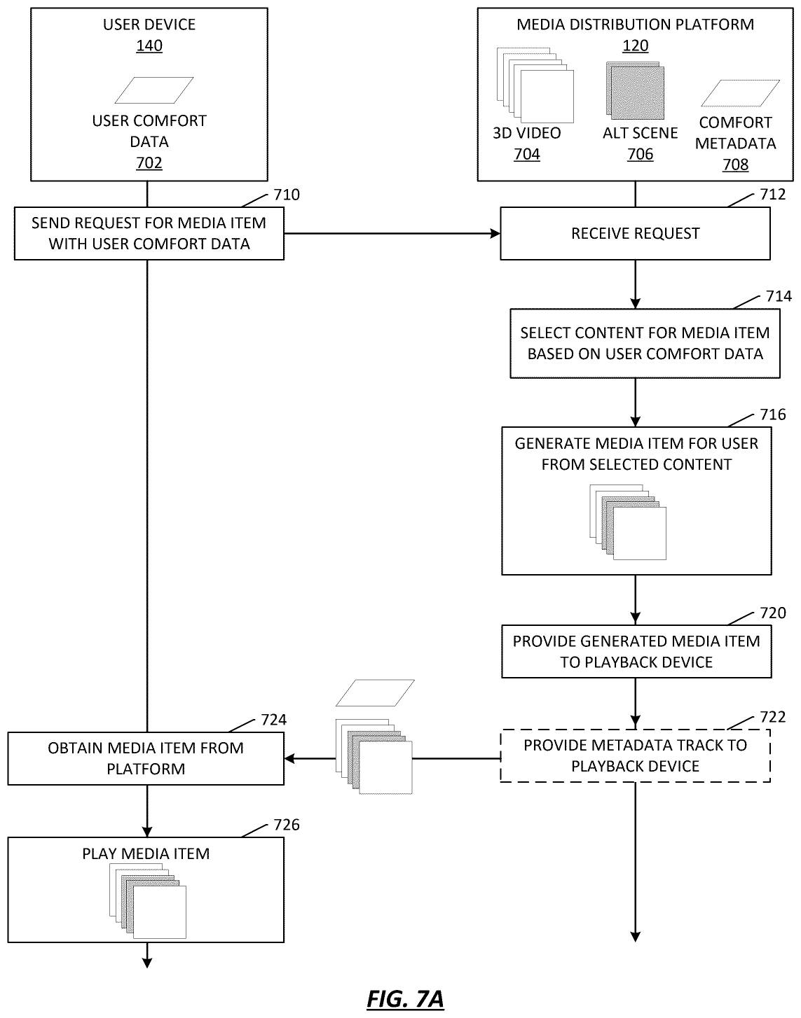

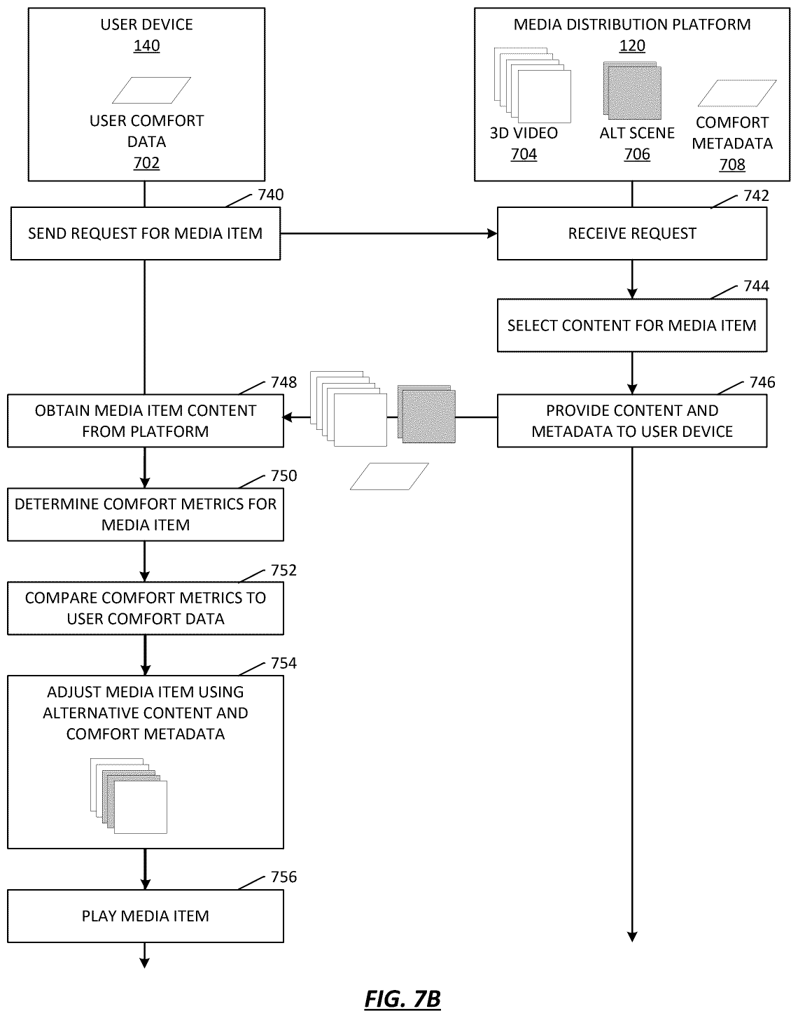

FIGS. 7A-7B show, in flow diagram form, example processes for utilizing comfort metadata, according to one or more embodiments. In particular, FIGS. 7A-7B show example techniques for using comfort metadata to adjust an immersive media item for playback. It should be understood that each of FIG. 7A and FIG. 7B depict example embodiments of the techniques described herein, and are not intended to limit the scope of the disclosure. For example, various processes may be depicted as being performed by particular devices, for example as described above with respect to FIG. 1. However, in some embodiments, the various processes may be performed by alternative or additional devices.

Turning to FIG. 7A, an interplay is depicted between a user device 140 and a media distribution platform 120. In some embodiments, the user device 140 may include user information, such as user comfort data 702. User comfort data 702 may correspond to user-specific comfort parameters. In some embodiments, the user-specific comfort parameters may indicate a motion level selected by a user, and/or may be at least partially automatically determined, for example based on physical characteristics of the user, such as eye measurements, age, and the like. Further, the user-specific comfort parameters may indicate particular phobia types or phobia identifiers, and/or intensity values for the phobias for which a corrective action should be performed. Media distribution platform 120 may host an immersive media item, such as 3D video 704. In addition, media distribution platform 120 can host ancillary content for the immersive media item, such as alt scene 706 and comfort metadata 708. In some embodiments, alt scene 706 may be an alternative version of a portion of the 3D video 704. Comfort metadata 708 may include a timed metadata stream which can be used to align motion information for the 3D video 704 and/or alt scene 706 using a timed metadata track. The comfort metadata 708 may include, for example, comfort metrics for one or more portions of the video content, camera motion information for a camera that captured the video content, or the like.

The flow diagram begins at block 710, where the user device 140 sends a request for a particular media item. The request may include an indication of user comfort data 702. For example, a user at user device 140 may access a media distribution platform 120 and select and immersive media item for playback. By selecting the media item, the request may automatically include user comfort data 702. Alternatively, a user of the user device 140 may include user comfort data 702 in the request.

At block 712, the media distribution platform 120 receives the request. At block 714, the media distribution platform 120 can select content for the requested media item based on the user comfort data 702. For example, the media distribution platform 120 can determine whether the 3D video 704 satisfies user comfort data 702. If 3D video 704 does not satisfy user comfort data 702, such as if an alert trigger would be satisfied based on the 3D video 704 and the user comfort data 702, the 3D video 704 may be adjusted with a corrective action to adjust the comfort metrics of the 3D video 704. Thus, the media distribution platform may select alt scene 706 along with 3D video 704 to satisfy the user comfort data 702.

The flow diagram proceeds to block 716, where the media item is generated for the user device 140 from the selected content. For example, the media distribution platform may select an alternate version of the 3D video that includes the alternate scene 706, or may generate a version of the 3D video 704 that includes alt scene 706. For example, the video frames corresponding to a particular scene having a motion event corresponding to high motion may be replaced with video frames corresponding to alt scene 706, which may have reduced motion. As a result, an alternate version of 3D video 704 may be generated which includes alt scene 706. As another example, media content may be adjusted so as to address comfort metrics. This may include, for example, shrinking a field of view of a scene to crop a portion of the scene causing a conflict with user comfort data. As another example, the media may be adjusted by changing an immersiveness of the data. For example, the media content may switch from a fully immersive view to a more limited view, such as through a portal, or a windowed view, or 3D media may be converted to 2D media, for example, by showing a single view of a stereo pair.

At block 720, the generated media item from block 716 is provided to the playback device, such as user device 140. Optionally, at block 722, the comfort metadata track 708 may also be provided to the user device 140. In some embodiments, the comfort metadata may not be needed by the user device 140, as the 3D video 704 has already been modified to adjust for the user comfort data 702. However, in some embodiments, comfort metadata 708 may be used at user device 140 to identify replacement, or alternative, scenes in the received version of the 3D video 704, to adjust other portions of the 3D video as received by the user device, or the like.

In some embodiments, the metadata track may be modified or generated to incorporate information that may be used by a playback device, such as user device 140, for rendering and/or presenting the media item. For example, the metadata track may contain lens-specific calibration data for each of the cameras that captured the media content, such as 3D video 704 and alt scene 706. For example, the 3D video may be captured by a multicamera system such that the image data is obtained by multiple lenses, each with their own distortions and optical distortions. To that end, the metadata track may include lens-specific calibration for each camera source. If desired, the lens-specific calibration data may be provided as separate metadata, for example the media distribution platform or other server may, as an initial step, provide lens calibration data for each of the cameras to the playback device; the media item may identify (e.g., via timed metadata) to the playback device which lens calibration data to use for playback of the media or any given media frame(s).

According to one or more embodiments, the metadata may include other information to adjust the media item for playback to address comfort metrics. For example, if the media item was generated to incorporate playback adjustments, instructions for those playback adjustments may be incorporated into the metadata. This may include, for example, an instruction to apply a treatment to frames of a portion of the media item, such as changing an immersiveness of the media item to a window or portal view, or to show a single view of a stereo pair to transform 3D media into 2D. Changes to the field of view may be instructed, for example, based on a spherical dynamic mask. The mask may indicate geometric information, such as a mesh, parametric functions, vertices, or the like that define an active volume for playback. In some embodiments, the playback adjustment instructions may be encoded in metadata with a reference to the particular frame or set of frames to which the adjustment should be applied. As another example, the instructions may be encoded in the form of a timed metadata track for use during playback. For example, the spherical dynamic mask may be encoded as a timed metadata track, for example on a per-frame basis.

The flow diagram proceeds to block 724, where the media item is obtained from the platform 120. Optionally, the metadata track is additionally received from the platform 120. The flow diagram concludes at block 726, where the media item is played at the user device 140. Notably, the media item played at block 726 differs from 3D video 704. However, a user at another user device, for which user comfort data is satisfied by 3D video 704 may have a different viewing experience, and thus may view 3D video 704 without adjustment, such as without the alternative scene. For example, a different user device may be associated with a higher threshold for media comfort data, and therefore will receive the unaltered version of 3D video 704 from the media distribution platform 120.

According to one or more embodiments, presentation of the media item at block 726 may include rendering the media item in accordance with the metrics and/or instructions encoded in the metadata. For example, the content for the media item may be adjusted at playback in accordance with the instructions to change a field of view, level of immersiveness, or the like. Further, additional adjustments may be made based on the metadata. As an example, the spherical dynamic mask for the field of view of the scene may be further adjusted based on lens-specific calibration information, or the like. Thus, the mask can be built and adjusted in real time during playback to adjust the field of view, to account for different sources of content, or the like. For example, the original media content may be captured in a lens projection space. During the process of transmission and rendering, the content may be encoded in other spaces. In some embodiments, the mask can be defined in any of these spaces, and can be used at a playback device to adjust a field of view.

Turning to FIG. 7B, an interplay is depicted between a user device 140 and a media distribution platform 120, in which a user device 140 is configured to adjust a media item based on comfort data. The flow diagram begins at block 740, where the user device 140 sends a request for a particular media item. The request may include an indication of user comfort data 702. For example, a user at user device 140 may access a media distribution platform 120 and select and immersive media item for playback. By selecting the media item, the request may automatically include user comfort data 702. Alternatively, a user of the user device 140 may include user comfort data 702 in the request. In some embodiments, the request 740 may be transmitted without the user comfort data 702.

At block 742, the media distribution platform 120 receives the request. At block 744, the media distribution platform 120 can select content for the requested media item based on the user comfort data 702. For example, the media distribution platform 120 may identify the 3D video 704 along with ancillary data for the 3D video 704, such as alt scene 706 and comfort metadata 708. In some embodiments, the media distribution platform 120 may obtain or have access to the user comfort data 702 and may select ancillary data for the 3D video 704 based on the user comfort data. For example, if 3D video 704 does not satisfy user comfort data 702, the media distribution platform 120 may select alt scene 706 along with 3D video 704 to satisfy the user comfort data 702. However, if the 3D video satisfies the user comfort data 702, the media distribution platform 120 may not select the alt scene 706. The flow diagram proceeds to block 746, where the content for the media item selected at block 744 is provided to the playback device, such as user device 140. As shown, the content may include 3D video 704, alt scene 706, and comfort metadata 708. Further, the metadata track may contain additional information for use by the user device 140, such as lens-specific calibration data for each of the cameras that captured the media content, such as 3D video 704 and alt scene 706.

The flow diagram proceeds to block 748, where the 3D video 704 and ancillary content, such as alt scene 706 and comfort metadata 708, are obtained from the platform. In some embodiments, the content may be downloaded or streamed from media distribution platform 120. For example, a content stream may include 3D video 704 and/or comfort metadata 708. As another example, the content may be downloaded to the user device 140 prior to playback.

The flow diagram continues to block 750, where comfort metrics are determined for the media item, or a portion of the media item. As described above, the comfort metrics may be determined for different segments of the media item, such as different scenes. According to some embodiments, the comfort metrics may be obtained from the comfort metadata 708. In some embodiments, the comfort metrics determined at block 750 may be adjusted or calculated based on comfort metadata 708 and local parameters, such as playback device characteristics or the like. In some embodiments, user activity may contribute to comfort metrics, such as if a user moves their head quickly, or in a same direction as motion in a scene. To that end, comfort metrics may be determined in real time based on user action.

At block 752 the comfort metrics are compared to user comfort data 702 for user device 140. According to one more embodiments, user comfort data 702 may be specific to a user of user device 140. The comfort metrics may indicate a score or parameters which are determined to be satisfied prior to presentation of the corresponding immersive media item or portion of the immersive media item. For example, the comfort metrics may indicate a maximum acceleration, velocity, or the like, and may be based on camera motion for a camera capturing the immersive media content, and/or motion characteristics of components of the captured scene. Further, the comfort metrics may indicate a measurement for abrupt changes of velocity, acceleration, direction, or the like, which may be allowed by the user.

The flow diagram continues to block 754, where the 3D video 704 is adjusted for the user device 140 using the received ancillary data. For example, an alternate version of the 3D video 704 may be generated to include the alternate scene 706. For example, comfort metadata 708 may indicate a scene in 3D video 704 associated with comfort metrics which fails to satisfy the user comfort data 702. Thus, the video frames corresponding to the particular scene may be replaced with video frames corresponding to alt scene 706. In some embodiments, adjusting the media item may also include adjusting for one or more cameras from which the media was captured. For example, the portions of the media item from the 3D video 704 and the alt scene 706 may have been captured by different cameras. In some embodiments, the media item content may include an indication of the cameras capturing different portions of the content such that the user device 140 can identify lens-specific calibration data for each of the cameras, and render the media item frames accordingly, thereby addressing optical distortions caused during image capture. In some embodiments, adjusting the 3D video data may include adjustments during playback, such as changing a level of immersiveness, changing a field of view, warping media content to compensate for scene and/or user motion, and the like.

The flow diagram concludes at block 756, where the media item is played at the user device 140. Notably, the media item played at block 756 differs from 3D video 704. However, a user device associated with motion comfort data 502 that is satisfied by 3D video 704 may have a different viewing experience, and thus may view 3D video 704 without adjustment.

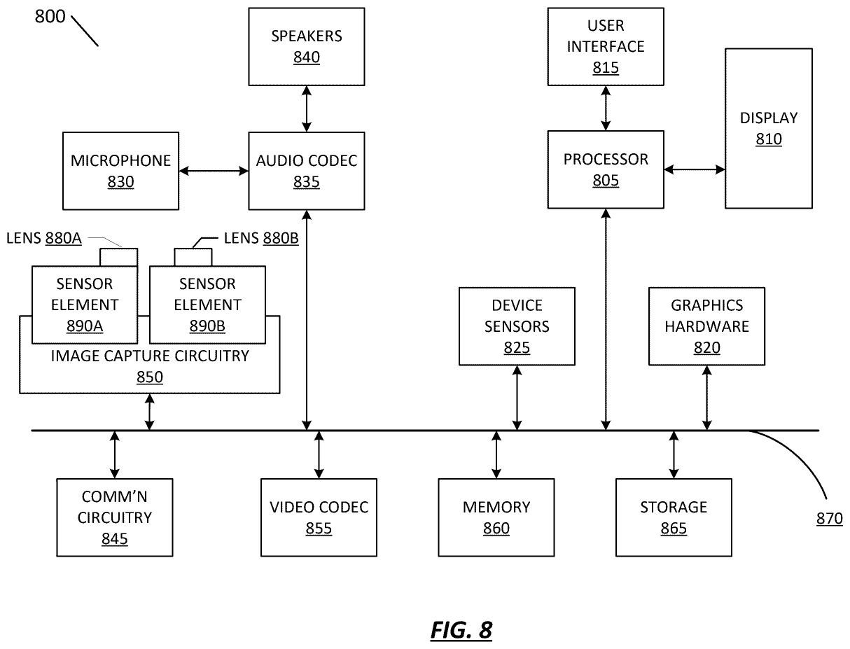

Referring now to FIG. 8, a simplified functional block diagram of illustrative multifunction device 800 is shown according to one embodiment. Multifunctional device 800 may show representative components, for example, for devices of media content system 100, media content distribution platform 120, and user device 140 of FIG. 1. Multifunction electronic device 800 may include processor 805, display 810, user interface 815, graphics hardware 820, device sensors 825 (e.g., proximity sensor/ambient light sensor, accelerometer and/or gyroscope), microphone 830, audio codec(s) 835, speaker(s) 840, communications circuitry 845, digital image capture circuitry 850 (e.g., including camera system) video codec(s) 855 (e.g., in support of digital image capture unit), memory 860, storage device 865, and communications bus 870. Multifunction electronic device 800 may be, for example, a digital camera or a personal electronic device such as a personal digital assistant (PDA), personal music player, mobile telephone, or a tablet computer.

Processor 805 may execute instructions necessary to carry out or control the operation of many functions performed by device 800 (e.g., such as the generation and/or processing of images or video as disclosed herein). Processor 805 may, for instance, drive display 810 and receive user input from user interface 815. User interface 815 may allow a user to interact with device 800. For example, user interface 815 can take a variety of forms, such as a button, keypad, dial, a click wheel, keyboard, display screen and/or a touch screen. Processor 805 may also, for example, be a system-on-chip such as those found in mobile devices and include a dedicated graphics processing unit (GPU). Processor 805 may be based on reduced instruction-set computer (RISC) or complex instruction-set computer (CISC) architectures or any other suitable architecture and may include one or more processing cores. Graphics hardware 820 may be special purpose computational hardware for processing graphics and/or assisting processor 805 to process graphics information. In one embodiment, graphics hardware 820 may include a programmable GPU.

Image capture circuitry 850 may include two (or more) lens assemblies 880A and 880B, where each lens assembly may have a separate focal length. For example, lens assembly 880A may have a short focal length relative to the focal length of lens assembly 880B. Each lens assembly may have a separate associated sensor element 890A and 890B. Alternatively, two or more lens assemblies may share a common sensor element. Image capture circuitry 850 may capture still and/or video images. Output from image capture circuitry 850 may be processed, at least in part, by video codec(s) 855 and/or processor 805 and/or graphics hardware 820, and/or a dedicated image processing unit or pipeline incorporated within circuitry 850. Images so captured may be stored in memory 860 and/or storage 865.

Sensor and camera circuitry 850 may capture still and video images that may be processed in accordance with this disclosure, at least in part, by video codec(s) 855 and/or processor 805 and/or graphics hardware 820, and/or a dedicated image processing unit incorporated within circuitry 850. Images so captured may be stored in memory 860 and/or storage 865. Memory 860 may include one or more different types of media used by processor 805 and graphics hardware 820 to perform device functions. For example, memory 860 may include memory cache, read-only memory (ROM), and/or random-access memory (RAM). Storage 865 may store media (e.g., audio, image, and video files), computer program instructions or software, preference information, device profile information, and any other suitable data. Storage 865 may include one more non-transitory computer-readable storage mediums including but not limited to magnetic disks (fixed, floppy, and removable) and tape, optical media such as CD-ROMs and digital video disks (DVDs), and semiconductor memory devices such as Electrically Programmable Read-Only Memory (EPROM), Electrically Erasable Programmable Read-Only Memory (EEPROM), or the like. Memory 860 and storage 865 may be used to tangibly retain computer program instructions or code organized into one or more modules and written in any desired computer programming language. When executed by, for example, processor 805, such computer program code may implement one or more of the methods described herein.

The scope of the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory computer readable medium comprising computer readable code executable by one or more processors to:
receive media data and comfort metrics for the media data;
determine, based on the comfort metrics, whether a compensation trigger is satisfied; and
in response to the compensation trigger being satisfied:
perform a corrective action on the media data to obtain adjusted media data, and
present the adjusted media data on a display of an electronic device.

2. The non-transitory computer readable medium of claim 1, wherein the compensation trigger is based on user-specific comfort data of a viewer.

3. The non-transitory computer readable medium of claim 1, wherein the compensation trigger is based on one or more physical characteristics of a viewer.

4. The non-transitory computer readable medium of claim 1, wherein the compensation trigger is based on a user-selected motion level.

5. The non-transitory computer readable medium of claim 1, wherein the computer readable code to determine whether the compensation trigger is satisfied comprises computer readable code to:
determine whether a change in acceleration satisfies a threshold.

6. The non-transitory computer readable medium of claim 1, further comprising:
select lens-specific calibration data for each of one or more portions of the media data in accordance with one or more capture devices of the one or more portions of the media data, and
wherein the lens-specific calibration data is used to obtain the adjusted media data.

7. The non-transitory computer readable medium of claim 1, wherein the computer readable code to perform a corrective action comprises computer readable code to:
determine a prescriptive motion based on the motion data; and
apply the prescriptive motion to the media data.

8. A method comprising:
receive media data and comfort metrics for the media data;
determine, based on the comfort metrics, whether a compensation trigger is satisfied; and
in response to the compensation trigger being satisfied:
perform a corrective action on the media data to obtain adjusted media data, and
present the adjusted media data on a display of an electronic device.

9. The method of claim 8, wherein the compensation trigger is based on user-specific comfort data of a viewer.

10. The method of claim 8, wherein the compensation trigger is based on one or more physical characteristics of a viewer.

11. The method of claim 8, wherein the compensation trigger is based on a user-selected motion level.

12. The method of claim 8, wherein performing the corrective action comprises:
adjusting a level of immersiveness of the media data.

13. The method of claim 8, wherein performing the corrective action comprises:
replacing the media data with alternative media data for playback.

14. The method of claim 8, wherein performing the corrective action comprises:
adjusting a field of view of the media data.

15. A system comprising:
one or more processors; and
one or more computer readable medium comprising computer readable code executable by the one or more processors to:
receive media data and comfort metrics for the media data;
determine, based on the comfort metrics, whether a compensation trigger is satisfied; and
in response to the compensation trigger being satisfied:
perform a corrective action on the media data to obtain adjusted media data, and
present the adjusted media data on a display of an electronic device.

16. The system of claim 15, wherein the comfort metrics are encoded in a metadata track for the media data.

17. The system of claim 16, wherein the corrective action is performed in accordance with rendering information in the metadata track.

18. The system of claim 15, wherein the computer readable code to perform a corrective action comprises computer readable code to:
adjust a level of immersiveness of the media data.

19. The system of claim 15, wherein the computer readable code to perform a corrective action comprises computer readable code to:
replace a portion of the media data with alternative media data for playback.

20. The system of claim 15, wherein the comfort metrics comprise an indication of a phobia event in the media data.
